(19) United States
(12) Patent Application Publication
(10) Pub. No.: US 2007/0029908 A1
(43) Pub. Date: Feb. 8, 2007

(54) Plasma display panel

(76) Inventors: Masashi Goto, Osaka (JP); Mikihiko Nishitani, Nara (JP); Katsumi Adachi, Nara (JP); Yoshinori Yamada, Osaka (JP); Satoshi Ikeda, Osaka (JP)

Correspondence Address: SNELL & WILMER L.L.P., 600 ANTON BOULEVARD, SUITE 1400, COSTA MESA, CA, 92626, US

(21) Appl. No.: 10/576,213

(22) PCT Filed: Oct. 28, 2004
(86) PCT No.: PCT/JP04/16050

§ 371 Date: Apr. 17, 2006

(30) Foreign Application Priority Data
Oct. 30, 2003 (JP) 2003-370379
Feb. 23, 2004 (JP) 2004-047023

(51) Int. Cl. H01J 21/10

(52) U.S. Cl. 313/306

(57) ABSTRACT

A plasma display panel in which a plurality of pairs of display electrodes extending in a row direction are aligned on a surface of a first substrate, a plurality of address electrodes extending in a column direction are disposed in a stripe pattern on a surface of a second substrate, the first and second substrates are disposed opposite each other so that the pairs of display electrodes and the address electrodes cross over sandwiching discharge space therebetween, and a discharge cell is formed corresponding to each crossover portion. The pairs of display electrodes are composed of a metallic material, each display electrode of each pair of display electrodes includes a base part extending in the row direction and a plurality of opposing parts extending from the base part into a discharge interval between the each pair of display electrodes. In each discharge cell, at least two discharge starting gaps are formed, each discharge starting gap existing between opposing parts that respectively belong each of the pair display electrodes and being at least partially over the address electrode. Discharge space exists between the each discharge starting gap and the address electrode, and peaks in electric field intensity are formed at each of the opposing parts.

### TECHNICAL FIELD

The present invention relates to a plasma display panel for use in an information display device, flat screen television, or the like.

### BACKGROUND ART

A plasma display panel (referred to hereafter as “PDP”), which is a type of gas discharge panel, is a self-emitting FPD (flat display panel) that displays images by causing excitation and emission in a phosphor via ultra-violet light generated by a gas discharge. A PDP is classified, according to the way it is powered, as being either an alternating current (AC) type or a direct current (DC) type. The AC-type has characteristics that are preferable to those of the DC type in areas such as luminance, emission efficiency, lifetime, and the like. Amongst AC-type models, the reflection type surface discharge model in particular has outstanding luminance and emission efficiency characteristics, and is widely used as a computer display, a large television monitor, a display device for industrial use, and the like.

FIG. 9 is a partial cross section perspective view showing the main constituents of a normal AC-type PDP. In the figure, the z-direction is the thickness direction of the PDP and the xy-plane corresponds to a plane parallel to the panel surfaces in the PDP. As shown in the figure, a PDP 1 is principally constructed from a front panel FP and a back panel BP whose main planes are disposed opposite each another.

Multiple pairs of display electrodes 4 and 5 (scan electrode 4 and sustain electrode 5) are disposed across the main surface on one side of a front panel glass 2, the substrate of the front panel FP, each pair of electrodes extending in the x-direction. The construction is such that a surface discharge (sustain discharge) takes place with the gap between each pair of display electrodes forming main discharge gaps. The display electrodes 4 and 5 of FIG. 9 are constructed from transparent electrodes 400 and 500, which are composed of wide bands of an ITO material, and band bases 401 and 501, which are composed of a layer metallic material disposed on the transparent electrodes 400 and 500.

The various scan electrodes 4 are electrically independent, and are supplied separately. The various sustain electrodes 5, on the other hand, are electrically connected to be at the same potential, and are supplied together.

On the main surface of the front panel glass 2, on which the display electrodes 4 and 5 are provided, coats of a dielectric layer 6 composed of an insulating material and a protective layer 7 composed of Magnesium Oxide are applied in the stated order so as to cover the display electrodes 4 and 5.

A plurality of address (data) electrodes 11 are provided in a stripe pattern with the electrodes extending in the y-direction on one main surface of the back panel glass 3, the substrate for the back panel BP. These address electrodes 11 are formed by, for instance, firing a compound material containing glass and Ag.

The main surface of the back panel glass 3 on which the address electrodes 11 are provided is coated, so as to cover the address electrodes 11, with a dielectric layer 10 composed of an insulating material. Barrier ribs 30 whose length direction lies in the y-direction are provided on the dielectric layer 10 in the intervals between adjacent address electrodes. Further, a phosphor layer 9R, 9G or 9B corresponding to one of red (R), green (G), or blue (B) and having an arc-shaped profile is formed on the surface of the dielectric layer 10 between the side-walls of each pair of adjacent barrier ribs 30.

The above front panel FP and back panel BP pair are disposed opposite one another such that length directions of the address electrodes 11 and the display electrodes 4 and 5 are perpendicular.

The front panel FP and the back panel BP are sealed together at their respective perimeters using a sealing part material such as a glass frit, or the like, to hermetically seal an internal space between the panels FP and BP. A discharge gas, such as Ne—Xe type (including 5%-30% Xe), is enclosed in the sealed internal part of the front panel FP and back panel BP at a prescribed pressure (commonly in the range 40 kPa-66.5 kPa).

Between the front panel FP and the back panel BP, spaces formed between the dielectric layer 6 and the phosphor layers 9R, 9G, 9B, and partitioned by two adjacent barrier ribs 30 form a discharge space 38. Further, regions where the pairs of display electrodes 4 and 5 and the single address electrodes 11 cross over sandwiching a portion of the discharge space 38 therebetween correspond to discharge cells 8 (see FIG. 1) for displaying an image.

When operating a PDP, image display is achieved by a process of starting address discharge between the address electrode 11 and one of the pair of display electrodes 4 and 5 in specified discharge cells, generating short wave ultra-violet light (Xe resonance line at wavelength of approximately 147 nm) via sustain discharge using the pair of display electrodes 4 and 5, and visible light being emitted from the phosphor layer 9R, 9G or 9B that receives the ultra-violet light. An image is displayed with gradation using a field gradation display method, which is commonly used as an image display method, a plurality of periods with different discharge counts (sub-fields) being selected according to the desired gradation.

PDPs of this type have thin screens and excellent moving picture quality, but in comparison to liquid crystal displays with similar thin screens, consume more power and have a higher peak current at emission, and control of these properties is therefore an issue.

Further, in terms of structure, since there is no clear partition between adjacent discharge cells 8 in the y-direction, when a specified discharge cell in a prescribed position discharges and emits during PDP operation, charged particles and the like leak into adjacent cells, and erroneous discharge sometimes occurs. This erroneous discharge leads to a reduction in resolution and deterioration in image quality, and a solution to this problem is therefore desired.

A method for reducing the peak current in order to reduce the power consumption has been proposed, for example, in Japanese laid-open patent application H8-315735 (see page 4 and FIG. 1 of this publication). Under this method each display electrode is split along its length to form a plurality of electrodes, thereby splitting the peak current into a plurality of smaller peak currents. Further, a different measure for reducing the power consumption is proposed in Japanese laid-open patent application 2002-134030. The proposal is for a construction (see FIG. 7) designed with the intentions of reducing the cost of the materials and manufacturing process by not using transparent electrodes and of reducing electrical resistance by using display electrodes 4 and 5 composed of thin metal lines 401, 417, 418, 501, 517 and 518.

Moreover, a method for preventing erroneous discharge in a PDP has been proposed in Japanese laid-open patent application 2000-133149 (see page 4 and FIG. 7) in which a method for providing an electric field concentration area in the middle of the discharge cell by forming two pairs of segments in the display electrodes inside the discharge cells is proposed. An alternative is described in laid-open patent application 2001-243883. This proposal describes a construction (see FIG. 8) in which the area of the display electrodes is reduced, and protrusions 419a, 419b, 519a, 519b are provided on the band-form electrode base parts 401 and 501. The electric field is concentrated using these protrusions, causing discharge to occur at these locations, and the discharge is made to expand as far as external protrusions 420a, 420b, 520a, and 520b.

Patent Document 1: Japanese laid-open patent application H8-315735

Patent Document 2: Japanese Laid-open patent application 2002-134030

Patent Document 3: Japanese laid-open patent application 2000-133149

Patent Document 4: Japanese laid-open patent application 2001-243883

### DISCLOSURE OF THE INVENTION

Problems that the Present Invention Aims to Solve

However, the method of splitting the display electrodes lengthwise as in Japanese laid-open patent application H8-315735 is problematic in that in exchange for splitting the peak discharge current, the firing voltage is increased. This method is undesirable because, in addition to increasing power consumption, an increase in the firing voltage increases the cost of materials, as it is necessary to increase the load resistance of the driver IC applying a voltage to the display electrodes. Moreover, in the construction described in Japanese laid-open patent application 2002-134030, when the thin metal lines are made wider (i.e. the area of the electrodes increased) to improve conductivity, the cell aperture ratio is reduced, and it is difficult to obtain sufficient luminance.

Moreover, although on one hand, the method described in Japanese laid-open patent application 2000-133149 prevents erroneous discharge, on the other, not only does peak current at discharge increase, but because the electric field is concentrated in the middle part of the discharge cell, the discharge intensity is highest at a central portion, and it is difficult to make effective use of the whole discharge space of the discharge cell. With this construction there is the further problem of luminance being likely to drop, even for a comparatively high reactive power, on account of the electrode segments being closely spaced.

Furthermore, in the method of Japanese laid-open patent application 2001-243883, as the crossover region, where the discharge space is sandwiched between the address electrodes and the display electrodes, becomes smaller, there is a danger that problems leading to a reduction in image display performance, such as erroneous addressing and discharge time lag, may occur.

For these reasons, it is difficult to solve the stated problems satisfactorily, whichever of the above described conventional methods is adopted. Further, although by using these methods the area of the display electrodes is reduced compared with a conventional construction, there is a danger that other problems such as a drop in luminance may occur as a result of this construction.

The present invention was conceived to solve the stated problems and has a first object of providing a PDP capable of exhibiting a favorable image display performance, and at the same time, achieving various cost reductions by reducing the materials and process costs, and by improving yield.

Further, a second object is to supply a PDP having an excellent emission efficiency, and a reduced power consumption achieved by reducing the reactive power during operation.

Moreover, a third object is to provide a PDP in which the occurrence of erroneous discharge due to discharge time lag in the address discharge, crosstalk, and the like is rare.

Means for Solving Stated Problems and Effects of the Invention

In order to solve the stated problems, the present invention is a plasma display panel having a construction in which a plurality of pairs of display electrodes extending in a row direction are aligned on a surface of a first substrate, a plurality of address electrodes extending in a column direction are disposed in a stripe pattern on a surface of a second substrate, the first and second substrates are disposed opposite each other such that the pairs of display electrodes and the address electrodes cross over sandwiching discharge space therebetween, and a discharge cell is formed corresponding to each crossover portion, wherein the pairs of display electrodes are composed of a metallic material, each display electrode of each pair of display electrodes includes a base part extending in the row direction and a plurality of opposing parts extending from the base part into a discharge interval between the each pair of display electrodes, and in each discharge cell, at least two discharge starting gaps are formed, each discharge starting gap existing between opposing parts that respectively belong to each of the pair display electrodes and being at least partially over the address electrode, and discharge space existing between the each discharge starting gap and the address electrode.

Here, each opposing part can be constructed from a connecting part that extends from the base part into the discharge interval between the pair of display electrodes and a main discharge part that extends in the row direction from the connecting part, the main discharge part being longer than a column-direction width of the connecting part, and each discharge starting gap can be formed between two main discharge parts that respectively belong to each of the pair of display electrodes.

Here, the opposing parts of each display electrode can be symmetrically positioned between the pair of display electrodes.

According present invention of the above construction, when voltages are applied to the pair of display electrodes during operation, electric field intensity peaks are formed at each of plurality of opposing parts (specifically the main discharge parts), and discharge occurs at each of these parts respectively. As the electric field is concentrated at each of these peak positions, a favorable start to the discharge is possible, even if the firing voltage is comparatively low.

Next, in correspondence with the positions of these peaks in field intensity, discharges occur and expand across the whole discharge cell forming an overall discharge of satisfactory dimensions. Since the display electrodes in the present invention are constructed from a metallic material, electrical resistance is reduced compared with when transparent electrodes are used, the effective voltage is higher because of the reduction in the driving voltage loss, and a reduction in the consumption of power taken to drive the PDP can be realized. Moreover, since the electrical resistance is low on account of the display electrodes being constructed from a metallic material, the time taken to form barrier charge on the display electrodes during driving (charge-up time) can be shortened, and a PDP capable of performing satisfactorily when driven at high speed can therefore be anticipated.

According to the construction of the present invention, both the luminance required to obtain satisfactory image display performance and a reduction in the power consumption can be acquired.

Moreover, in the present invention, by adjusting the relative positions of the address electrode and the discharge starting gap the region of crossover between the address and display electrodes sandwiching the discharge space (the effective discharge area), which is the discharge starting position, is to some extent secured. This is desirable because address discharge is easier and erroneous addressing and discharge time lag can be suppressed.

Further, in each discharge cell, the various opposing parts can be provided with line symmetry about the address electrode.

Further, the opposing parts can be disposed at a plurality of locations along each display electrode in the row direction, and each gap between adjacent opposing parts of a same polarity can be narrower than a width of the address electrode.

With this construction, it is possible to cause discharge to start at a position that is closer to the barrier ribs where the phosphor layer is applied than the center of the discharge cell is. Hence, the ultra violet light generated via the discharge arrives more effectively at the phosphor layers, and an increase in emission efficiency can be achieved.

Further, in each discharge cell, each display electrode can provided with a plurality of the opposing parts disposed in a column direction, and a width of each discharge starting gap can be set to be narrower than a width of the address electrode.

Here auxiliary barrier ribs can be individually disposed extending in the row direction between discharge cells that are adjacent in the column direction.

Via the use of this kind of auxiliary barrier rib, it is possible to employ the barrier effect of the auxiliary barrier ribs to control the progress of discharge (charge particles) in the column direction inside the discharge cell. The leakage of charged particles generated in one cell into a cell that is adjacent in the column direction is thereby suppressed, and the occurrence of erroneous discharge, due to cross-talk and the like, effectively prevented.

Here, in the present invention, when the opposing parts are disposed in the column direction so as to interleave with each other and discharge is caused to occur between the pair of display electrodes, the main discharge direction is the row direction, which is different from the main discharge direction in conventionally arranged display electrodes. With such a construction, it is comparatively difficult for charged particles to leak into adjacent discharge cells but it is desirable, nevertheless, to provide auxiliary barrier ribs because doing so further heightens effects such as cross-talk prevention and discharge time lag prevention.

Further, a dielectric layer can be provided so as to cover the display electrodes on the surface of the first substrate on which the display electrodes are aligned, and in each discharge cell, a thin layer area can be provided in the dielectric layer in correspondence with each position of the main discharge gaps.

Moreover, in each discharge cell, one or more thick layer area can be provided in the dielectric layer in correspondence with positions of gaps between adjacent opposing parts of a same polarity.

The provision of thin layer areas and thick layer areas in this way enables a plurality of electric field intensity peaks to be formed with increased reliability inside the discharge cell, and is therefore desirable.

Thus with a PDP of the present invention, due its favorable power consumption when driven, and due to effects such as improved emission efficiency, cross-talk prevention, and a capability to prevent unnecessary discharge, a superior image display performance can be realized.

Furthermore, with a PDP of the present invention, because the display electrodes are formed exclusively from a metallic material, it is possible to achieve material and processing savings in comparison to the conventional constructions that use a combination of metal and transparent electrodes. Thus, based on these savings, a substantial cost reduction can be anticipated.

### BEST MODE FOR CARRYING OUT THE INVENTION

Embodiments and variations of the PDP of the present invention are successively described below, with reference to the drawings.

Note that the main characteristics of the PDP of present invention are in the construction of the discharge cell shown in FIGS. 1-6 below, and otherwise the construction of the PDP of the present invention substantially resembles the conventional construction of FIG. 9. On this account, repetitive descriptions are omitted.

### First Embodiment

The First Embodiment relates to a PDP in which it is possible to reduce the reactive power and reduce the firing voltage.

FIG. 1 is a plan view of the construction of a discharge cell of a PDP the First Embodiment.

In FIG. 1, the pair of display electrodes 4 and 5 are constructed from band-shaped base parts 401 and 501, which are composed of an Ag material and extend in the x-direction, and opposing parts 400a, 400b, 500a and 500b, which are disposed in symmetry with each other between the pair of display electrodes 4 and 5.

Moreover, the opposing parts 400a, 400b, 500a, and 500b are composed of a plurality of (here in discharge cell 8, a total of four) rectangular main discharge parts 403a, 403b, 503a, 503b and connecting parts 402a, 402b, 502a, and 502b, which respectively connect to the main discharge parts 403a, 403b, 503a, 503b to form substantially L-shaped hooks. Here, the main discharge parts 403a, 403b, 503a and 503b are disposed in opposing pairs so as to form discharge starting gaps Gf at a plurality of locations (here, at two locations) in the row direction.

Beveled parts r are formed where the corners of the main discharge parts 403a, 403b, 503a, 503b have been removed. If the corners of the main discharge parts 403a, 403b, 503a, 503b are sharp, charge becomes over-concentrated at these corners under certain circumstances when the PDP is driven, causing erroneous discharge to occur, and the beveled parts r are therefore provided to diffuse the charge to some extent, and prevent this effect.

Further, instead of providing the bevel parts r the corners of the main discharge parts 403a, 403b, 503a, and 503b can undergo a rounding off process.

The opposing parts 400a, 400b, 500a, and 500b are separated such that a gap GG is formed between adjacent main discharge parts 403a and 403b (503a and 503b) of the same polarity. The address electrode is constructed from two branch parts 11a and 11b that extend in the y-direction, and positioned such that the discharge starting gaps Gf between the pairs of main discharge parts 403a, 403b, 503a, 503b are directly above the branch parts 11a and 11b and discharge space 38 exists between the discharge starting gaps Gf and the branch parts 11a and 11b.

As an example of some possible sizes, the film thickness of the Ag material (Ag film) of which the display electrodes 4 and 5 are entirely composed can be set to be approximately 1 μm to 3 μm, the band-shaped base parts 401 and 501 to have a y-direction width of 60 μm to 100 μm in order to reduce electrical resistance, the main discharge parts 403a, 403b, 503a, and 503b to have a y-direction width of approximately 20 μm to 100 μm, and the connecting parts 402a, 402b, 502a, and 502b to have an x-direction width of 20 μm to 40 μm in order to secure the cell aperture ratio, but the present invention, needless to say, is not limited to these values. However, if the various parts of the display electrodes 4 and 5 are not sufficiently wide, the address discharge is unstable, and it is no longer possible to store sufficient barrier charge inside the discharge cell 8. On the other hand, if the various parts of the display electrodes 4 and 5 are widened, the cell aperture is lowered in proportion. Care is therefore necessary to ensure that the widths of the various parts of the display electrodes 4 and 5 are appropriate.

Further, a thick layer area B and thin layer areas A are provided in the dielectric layer 6 of the front panel FP. The thick layer area, where the film is comparatively thick (protruding approximately 10 μm to 40 μm from the main part of the surface), is provided in a position corresponding to the gap GG. The thin layer areas A, where the film is comparatively thin (depressions sinking approximately 5 μm below the level of the main part of the surface), are disposed in positions corresponding to the respective discharge gaps Gf.

The thin layer areas A and the thick layer area B can be formed using methods such as photolithography using a photosensitive dielectric sheet and printing.

Note that, forming a depression part in the dielectric layer over the display electrodes has been considered before with the aim of reducing the firing voltage. However, in this former construction a film disparity (depression depth) of approximately 15 μm to 20 μm was required in order to effectively reduce the firing voltage. However, there was a problem in that, though a deep disparity of this type enables a reduction in the discharge voltage to be achieved, the generated discharge is confined to the depression and has difficulty expanding any further. In the present invention, on the other hand, the aim is to modulate the potential distribution within the discharge cell and to generate a plurality of electric field peaks, and, unlike before, there is no need to directly reduce the firing voltage. Hence, it is not necessary to provide a large difference in the thickness of the dielectric layer for the depression. In practice, if a shallow depression is approximately 5 μm deep, like the one described above, or less, the present invention is effective and the problem of the discharge being confined to the depression part does not occur.

Further, in the former construction, if the relative positions of the thin layer areas in the dielectric glass shift with respect to the transparent electrode within the display electrode, the area of the transparent electrode corresponding with a portion inside the thin layer areas changes. This causes irregularity in the interrelated action of the thin layer areas and the transparent electrode, increasing the likelihood of variation in the discharge voltage between the discharge cells, and this results in non-uniform luminance across the panel as a whole.

At present, a screen printing method is normally used to form the dielectric layer, but it is difficult to reduce the variation described above to a point where it is no longer a problem. Further, using a high precision photo lithographic method to form the dielectric film has the drawback of substantially increasing the cost. In the present invention, on the other hand, because the display electrodes are constructed from metal, if the dielectric layer depression part is formed in an area including the main discharge parts of the display electrodes, the area of the display electrodes corresponding with the thin layer areas can be kept mostly free of variation.

For the dielectric layer 6, it is preferable to use a material such as SiO₂, which has a lower dielectric ratio and a higher pressure resistance than low melting point glass.

Here, in the example of FIG. 1, the barrier ribs 30 composed of column-direction sections 301 and row-direction sections (auxiliary barrier ribs) 302 form a matrix in the interests of preventing cross-talk, but barrier ribs with a stripe form similar to those in conventional PDPs are also acceptable.

In the First Embodiment the display electrodes 4 and 5 are constructed from an Ag material, but it is possible to construct them from other metallic materials, such as a compound Cr/Cu/Cr film, an Al-Nd film, or elements such as Cu, Al, Cr or Ti.

Note also that, though not shown in the drawings, a black matrix (BM) may be provided along the column-direction section 301 of the barrier ribs 30 in order to improve color reproduction.

According to the First Embodiment of a PDP 1 having the above construction, each discharge starting gap Gf is disposed directly above a branch part 11a or 11b, and hence, the discharge start positions are close to the branch parts 11a and 11b. Because of this, beneficial effects including the simplified generation of address discharge, and the suppression of the problems of erroneous addressing and discharge time lag are obtained. Specifically, in a construction in which the area of display electrodes 4 and 5 has been reduced, such as in previous technology (for example, laid-open patent application 2001-243883), region of crossover region between the address electrode and the display electrodes (particularly the scan electrode 4), where the discharge space is sandwiched, is likely to be dramatically reduced (i.e. the effective discharge area is reduced), resulting in instability in the address discharge. However, in the First Embodiment the area of the crossover region (effective discharge area) is guaranteed to some extent via the means described above, and hence, unsatisfactory address discharge is eliminated.

Moreover, since in the discharge cell 8 the main discharge parts 403a, 403b, 503a and 503b are disposed in pairs separated by relatively narrow discharge starting gaps Gf, when the panel is driven a plurality of electric field intensity peaks are formed in proximity to the two discharge starting gaps, and discharge in the column direction is consequently achieved at a plurality of locations (here, at 2 separate places in the row direction). Consequently, the scale of the discharge at the instant discharge occurs is large in comparison to previous technologies, and thus, it is possible to reliably obtain a satisfactory brightness and scale of discharge, and the PDP exhibits an excellent image display performance.

Further, in the First Embodiment, by concentrating electric field in proximity to each of the discharge starting gaps Gf, intense electric fields are formed in parts of the discharge cell, and discharge can be made to occur relatively easily. For this reason, a reduction in the firing voltage needed to drive the PDP can be anticipated.

Moreover, in the First Embodiment, by ensuring the dielectric layer 6 is of a certain thickness in the thick layer area B, the capacitance of parts of the layer formed between the display electrodes 4 and 5 is kept low, and the storage of barrier charge is suppressed. Inside the discharge cell this has the effect of distributing (electric field modulation) electric field intensity peaks to locations on either side of the thick layer area B that store less barrier charge (i.e. the discharge starting gaps Gf). In contrast to the thick layer area B, the thin layer areas A of the dielectric layer 6 store a large amount of barrier charge, and generating discharge is simpler in these areas. Hence, discharge can take place at a relatively low firing voltage in areas corresponding to the thin layer areas A. Thus, the degree of certainty that the start of the discharge will occur in the discharge starting gaps Gf increases.

Note that the above described thin layer areas A and thick layer area B are not essential elements of the construction; it is acceptable to provide only one of the two, or to provide neither. However, to be sure of obtaining a reduction in the firing voltage and a plurality of discharge starting positions it is preferable to include both as stated.

Further, in the First Embodiment, since the main discharge parts 403a, 403b, 503a and 503b that form the discharge starting gaps Gf are provided at least gap GG apart, the capacitance between the pair of display electrodes 4 and 5 is kept lower than in a conventional structure (see FIG. 9) containing transparent electrodes 400 and 500. In a discharge cell 8 selected to be switched off in the sustain discharge period, the resulting beneficial effect is to suppress the generation of stored charge not contributing to discharge, otherwise known as reactive power, which is consumed according to the capacitance between the display electrodes 4 and 5.

Further, on account of the main discharge parts 403a, 403b, 503a and 503b which sandwich the gaps GG being provided close to the barrier ribs 30, discharges occurring at the main discharge parts 403a, 403b, 503a and 503b can be brought closer to the phosphor layers 9R, 9G and 9B (see FIG. 9) that have an arc-shaped profile in cross section. Consequently, ultra-violet light from the discharge arrives effectively at the phosphor layers 9R, 9G and 9B, and an increase in emission efficiency is achieved.

Further, in the construction of FIG. 1, owing to the provision of the row direction sections 302 of the barrier ribs 30 between cells that are adjacent in the y-direction, discharge occurring in one discharge cell 8 is prevented from expanding into adjacent cells, and erroneous discharge due to cross talk and the like is effectively suppressed.

Variations 1, 2 and 3

In the First Embodiment, the opposing parts 400a, 400b, 500a and 500b are described as L-shaped hooks but the present invention is not limited to this form. By adjusting the main discharge parts 403a, 403b, 503a and 503b, the connecting parts 402a, 402b, 502a, and 502b and the method of connection to the band-shaped base parts 401 and 501, shapes such as a T-shape (the connection part is provided close to a central area of a side portion of the main discharge part), a Z-shape (the main discharge part and the band-shaped base part are connected using a diagonal connecting part), and the like can be provided.

The only differences between FIG. 2 and the construction of FIG. 1, which is a variation (Variation 1) of the First Embodiment, are the form of the opposing parts and the lack of provision of a thick layer area B.

The opposing parts 400a and 400b shown in FIG. 2 are constructed as a triangular frame with two connecting parts 402a, 402b, 502a, 502b, 404a, 404b, 504a and 504b connecting to the ends of each of the main discharge parts 403a, 403b, 503a and 503b respectively.

With the type of construction of Variation 1, not only are effects similar to the First Embodiment achieved, but the conductivity of the display electrodes 4 and 5 is improved by the increase in the number of connecting parts 404a, 404b, 504a, 504b, and discharge can take place with a higher efficiency. Further, as each of the main discharge parts 403a, 403b, 503a and 503b connects to two connecting parts 402a, 402b, 502a, 502b, 404a, 404b, 504a and 504b, even if line breakage occurs in one of the connecting parts, the electrical connection is maintained between the main discharge part and the band-shaped part via the other connecting part. It follows that a line breakage in one of the main discharge parts can be electrically confined to inside the discharge cell, and the danger of a loss of performance occurring (as a result of faults such as line breakage due to pattern defects) can be avoided. Hence, in the display electrodes 4 and 5, if for example, the connecting parts are formed of thin lines in order to increase the cell aperture ratio and a line breakage occurs in one of them, the probability that the PDP can be made to function normally is increased, and the yield of the manufacturing process can be improved.

Note that, though in the construction of FIG. 2 a thick layer area B is not provided, since branch electrodes 11a and 11b lie directly below the discharge starting gaps Gf, it is possible to satisfactorily secure a plurality of discharge start positions in the discharge cell 8.

Note also that, by forming the connecting parts 404a, 404b, 504a and 504b metallic lines, the cell aperture ratio is not significantly reduced.

In the present invention, improvements in the conductivity and luminance can be achieved by increasing the areas of the display electrodes 4 and 5 while paying attention to the cell aperture ratio. FIG. 3, which is referred to below, shows modifications made to the construction of FIG. 1 with this in mind.

Variation 2 shown in FIG. 3 differs from the construction of FIG. 1, firstly, in the provision of second band shape base parts 406 and 506 between each of the main discharge parts 403a, 403b, 503a and 503b and band-shaped base parts 401 and 501, and secondly, in the provision of connecting parts 407a, 407b, 507a and 507b. Further, in this example construction, with a thick layer area B not being provided, a wide part 11c in a position corresponding to the gap GG between the opposing parts 500a and 500b is formed in the band-shaped address electrode 11. The wide part 11c is provided so as to be partially overlapped by the discharge starting gaps Gf.

In Variation 2 having the above construction, besides achieving similar effects to the First Embodiment and Variation 1, the additional provision of the second band-shaped base parts 406 and 506 and connecting parts 407a, 407b, 507a and 507b gives an improvement in the conductivity of the display electrodes 4 and 5 by increasing the electrode areas, and a corresponding reduction in power consumption can therefore be anticipated. Further, favorable address discharge reliability is achieved as a result of the provision of the wide part 11c.

Note that even if the electrode area is not increased to any great extent, it is possible to ensure constant scale of discharge using the following method. FIG. 4 shows the construction of the variation in question (Variation 3).

The display electrodes 4 and 5 of the figure constitute connecting parts 402a, 402b, 502a, and 502b, which extend from the band-shaped base parts 401 and 405 along the barrier ribs 30, and main discharge parts 403a, 403b, 503a and 503b, which are respectively connected to the connecting parts 402a, 402b, 502a, and 502b. Further, the display electrodes 4 and 5 have a construction in which adjacent same-polarity main discharge parts 403a and 403b, and 503a and 503b, are connected to indented connecting parts 408 and 508 respectively. Further, the indented connecting parts 408 and 508 are disposed so as to overlap the band address electrode 11, and so as the discharge starting gaps Gf existing between the main discharge parts 403a and 503a, and between 403b and 503b, partially overlap the address electrode 11. Further, thin layer areas A are disposed in positions corresponding to the discharge starting gaps Gf.

According to variation 3 having the above construction, besides beneficial effects similar to the First Embodiment and Variations 1 and 2 being achieved, since the electrode area that affects the aperture ratio of the discharge cell 8 is comparatively small, the cell aperture ratio is improved, and based on the superior luminance, image display performance can be secured. Further, by providing the indented connecting parts 408 and 508, the conductivity between the main discharge parts 403a and 403b, and 503a and 503b, is maintained, and this enables a scale of discharge that is favorable from the beginning of the discharge to be achieved.

Note that in constructions of Variations 1 to 3 shown in FIGS. 2, 3 and 4 respectively, because the main discharge parts 403a, 403b, 503a, and 503b each connect to a plurality of connecting parts, even in the unlikely event of line breakage occurring in one of the connecting parts, power can still be supplied to the main discharge parts. Hence, these constructions have the important effects of improving the yield of the PDP manufacturing process and achieving cost reductions.

### Second Embodiment

FIG. 5, referred to below, shows the construction of a discharge cell 8 in a PDP 1 of the Second Embodiment.

While the construction of PDP 1 of the Second Embodiment resembles the First Embodiment in that, for example, the display electrodes 4 and 5 are formed from an Ag material and thin layer areas A are provided in combination with discharge starting gaps Gf, the construction of the Second Embodiment also has the following distinguishing characteristics.

As shown in FIG. 5, the display electrodes 4 and 5 include band-shaped extending parts 412a and 412b extending along barrier ribs 30 from band-shaped base parts 401 and 501. These extending parts 412a and 512a partially interleave with each other in the interval between the pair of display electrodes 4 and 5. Also, in the discharge cell 8, the extending parts 412a and 512a are provided with L-shaped hook opposing parts 416a, 416b, 516a and 516b separated by the gaps GG. The opposing parts 416a, 416b, 516a and 516b are constructed from connecting parts 402a and 502a and main discharge parts 403a and 503a in a similar way to in the First Embodiment.

Thus, in the second the Second Embodiment, discharge starting gaps Gf exist between the opposing main discharge parts 403b and 503b of the opposing parts 416a, 516b, 516a, and 416b. The discharge starting gaps Gf are positioned directly above the address electrode 11, discharge space existing between the discharge starting gaps Gf and the address electrode 11, and the discharge starting gaps Gf are set to be narrower than the width of the address electrode.

Thus, in the Second Embodiment, in each discharge cell 8, discharge starting gaps Gf are respectively disposed at each of two locations in the column direction, each discharge gap having a discharge direction in the row direction.

The overall pattern formed by the display electrodes is such that adjacent discharge cells 8 are symmetrical in the x-direction about the barrier ribs 30.

Further, in the Second Embodiment, thin layer areas A in the dielectric layer 6, which were described in the First Embodiment, are formed at positions (two places in discharge cell 8) corresponding to the discharge starting gaps Gf.

According the PDP 1 of the Second Embodiment having display electrodes 4 and 5 of the above construction, in addition to effects similar to those of the First Embodiment, the following effects can be further anticipated.

Namely, in a construction in which discharge gaps Gf are provided at two places in the column direction such as in the Second Embodiment, the following is a distinguishing feature. The length (y-direction length) of main discharge parts 403a and 503a can be extended to some degree, thereby increasing the area in which the discharge starting gaps Gf are formed, and enabling, for example, the scale of the discharge at the instant that discharge starts to be enlarged. Generally, in the Second Embodiment, it is a simple matter to extend the length of the main discharge parts 403a and 503a in this way because the discharge cell 8 is of a shape whose length is in the y-direction.

Moreover, as an effect of driving the PDP, in any given discharge cell 8, during the address period when power is supplied from an external source to the various electrodes 4, 5 and 11, address discharge occurs between the address electrode 11 and the display electrode (scan electrode) 4. Then, at the beginning of the discharge sustain period, when a voltage is applied to the display electrodes 4 and 5 of the given discharge cell, electric field intensity peaks are formed in the discharge gaps Gf between the opposing parts 416a and 516b, and 516a and 416b, and discharge (in the row direction) occurs in these areas. Next, discharge expands rapidly in the xy-directions at the display electrodes 4 and 5 due to the existence of the discharge starting gaps at two places in the discharge cell 8, and a discharge of a satisfactory scale is formed across the whole of the opposing the parts 416a and 516b and the opposing parts 516a and 416b.

Note that it is desirable to make the intervals between the display electrodes 4 and 5 at the opposing parts 416a and 516b and at the opposing parts 516a and 416b the shortest intervals between the display electrodes 4 and 5 because doing so prevents short circuit discharge in undesirable parts of the discharge cell 8. If, for example, the interval between the opposing part 516b and the base part 401 is the shortest, there is every possibility that undesirable short-circuit discharge will occur between the two parts. To avoid such a situation, the above-described precautionary measure is necessary.

Note also that by disposing the opposing parts 416a and 516b and the opposing parts 516a and 416b of the display electrodes 4 and 5 so as to be separated by the gaps Gf, the capacitance between the display electrodes 4 and 5 is reduced, and the reactive power is consequently curtailed.

Furthermore, maintaining suitable spaces between the opposing parts 416a and 416b and opposing parts 516a and 516b, and the respective base parts 501 and 401 of the other electrode is desirable both in terms of preventing short-circuit discharge and reducing reactive power.

Moreover, during discharge, since in the discharge cell 8 electric field intensity peaks are formed at each of the thin layer areas A of the protective layer 6 in correspondence with the discharge starting gaps Gf, the generation and expansion of the maintain discharge effectively depends on the positions of the peaks, and a substantial improvement in luminance can be anticipated.

Note that, as in the First and Second Embodiments, when thin layer areas A are provided in a number of places in the discharge cell 8, an according number of electric field intensity peaks are formed inside the discharge cell, and discharge occurs at positions corresponding to the various peaks. The manner of expansion of this discharge is clearly preferable when compared with a construction having a thin layer area with a large area in a single location. For this reason it is acceptable to proved thin layer areas A at two or more locations inside the cell.

Though in the Second Embodiment an example construction combining the opposing parts 416a, 416b, 516a and 516b, and the thin layer areas A has been indicated, provision of the thin layer areas A of the dielectric layer is not strictly necessary.

Further, the number of opposing parts that include extending parts is not limited to the number in the construction of FIG. 4, and may be modified as appropriate.

Moreover, if the main discharge parts 403a and 503a are too long in the column direction, unwanted short circuit discharge will occur between the opposing discharge electrodes, and so care must be taken in order to avoid this.

Note also that, though not shown in FIG. 5, auxiliary barrier ribs (row-direction section 302) similar to those of the First Embodiment may be provided between discharge cells 8 adjacent in they-direction (column direction). In the Second Embodiment, because in the discharge cell 8 the extending parts 412a and 512a are disposed so as to interleave with each other in the interval between the pair of display electrodes 4 and 5, the discharge direction at the opposing parts 416a, 416b, 516a and 516b is the row direction. Due to this property of this kind of construction, it is relatively difficult for charge particles to leak into adjacent discharge cells 8 in the column direction. However, by adding auxiliary barrier ribs (the row-direction sections 302) to this construction the effects of preventing cross-talk and preventing discharge time lag can be heightened, and it is therefore desirable to do so.

Variation 4

In the construction of the Second Embodiment, the reliability of the address discharge, in particular, is high (improved discharge probability and suppressed discharge time lag) due to the overlap of the discharge starting gaps Gf and the address electrode 11. This result can be further improved by increasing the address electrode 11 area that is overlapped by the discharge starting gaps Gf via the discharge space, thereby enlarging the plan view region of crossover between the discharge starting gaps Gf and the address electrode 11.

FIG. 6 shows a construction (Variation 4) with rectangular widening parts 11d provided in the areas of the address electrode corresponding to the discharge starting gaps Gf. Connecting parts 411a, 411b, 511a and 511b have been added to the main discharge parts 403a and 503a, supplementing the construction of FIG. 4, with the dual intentions of ensuring conductivity in the event of line breakage and improving the yield rate.

With this construction too, beneficial effects similar to those of Embodiment 2 and other beneficial effects are obtained. The latter include reliability of the address discharge and an image display performance that is maintained in the event of display electrode 4 and 5 line breakage, as well as cost reductions due to an improved yield.

Additional Items

In the First to Fifth Embodiments, constructions in which pairs of display electrodes were similarly disposed in the column direction (the so-called ABAB arrangement) were shown. However, the present invention is not limited to this arrangement, and may equally be of a construction in which scan electrodes are disposed adjacent to one another, as are the sustain electrodes, and the these pairs of adjacent address electrodes alternate (the so-called ABBA arrangement).

### INDUSTRIAL APPLICABILITY

The PDP of the present invention is of use in lightweight large screen televisions and the like, and is also suitable for application in devices such as industrial-use display devices.

### BRIEF DESCRIPTION OF THE DRAWINGS

FIG. 1 shows a construction of a discharge cell of a PDP of the First Embodiment;

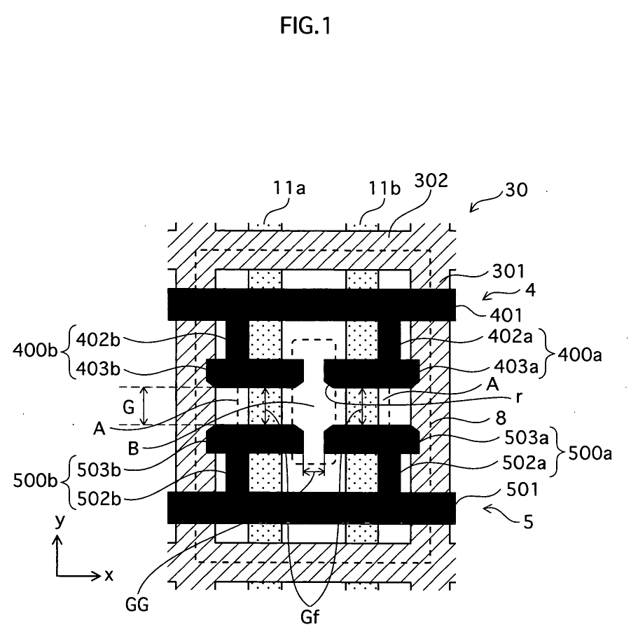

FIG. 2 shows a construction of a discharge cell in a PDP from a variation of the First Embodiment;

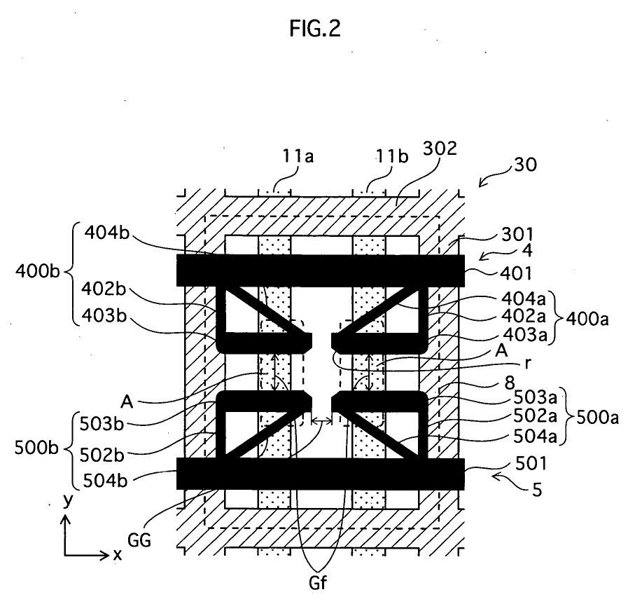

FIG. 3 shows a construction of a discharge cell in a PDP from a variation of the First Embodiment;

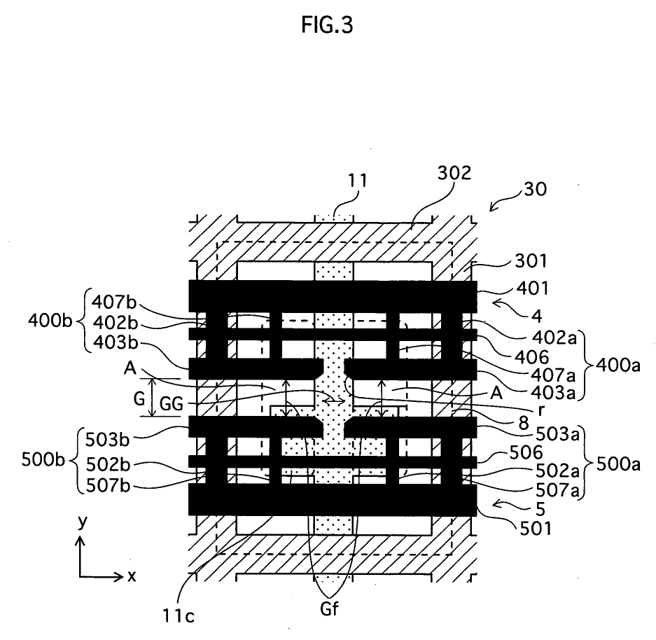

FIG. 4 shows a construction of a discharge cell in a PDP from a variation of the First Embodiment;

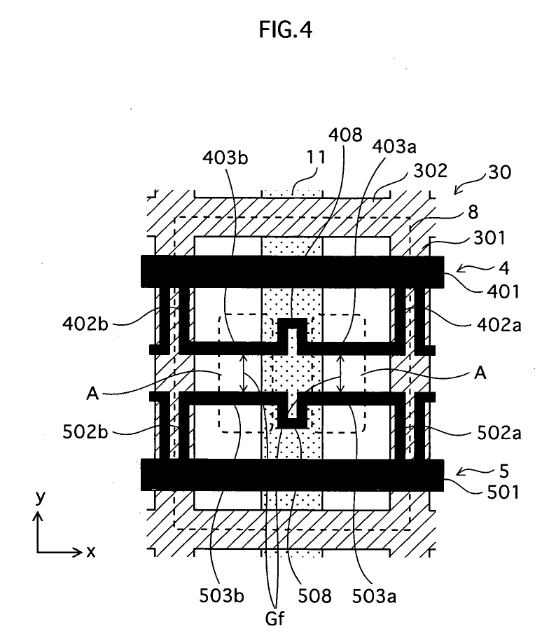

FIG. 5 shows a construction of a discharge cell of a PDP the Second Embodiment;

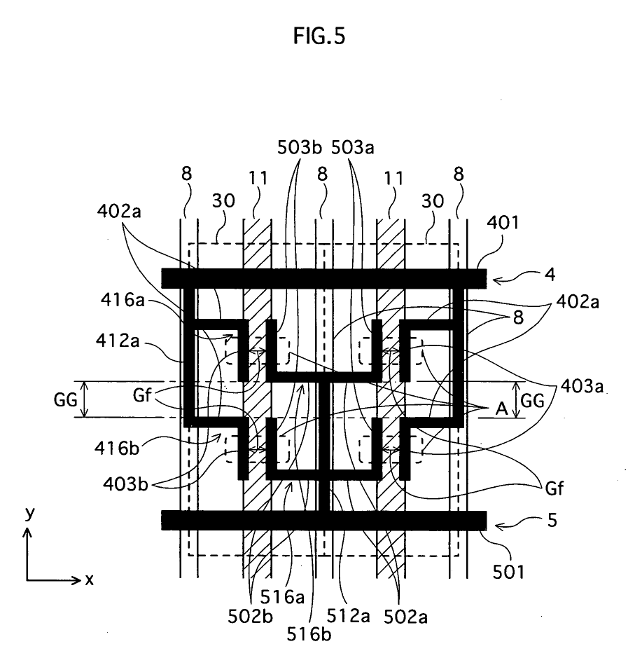

FIG. 6 shows a construction of a discharge cell in a PDP from a variation of the Second Embodiment;

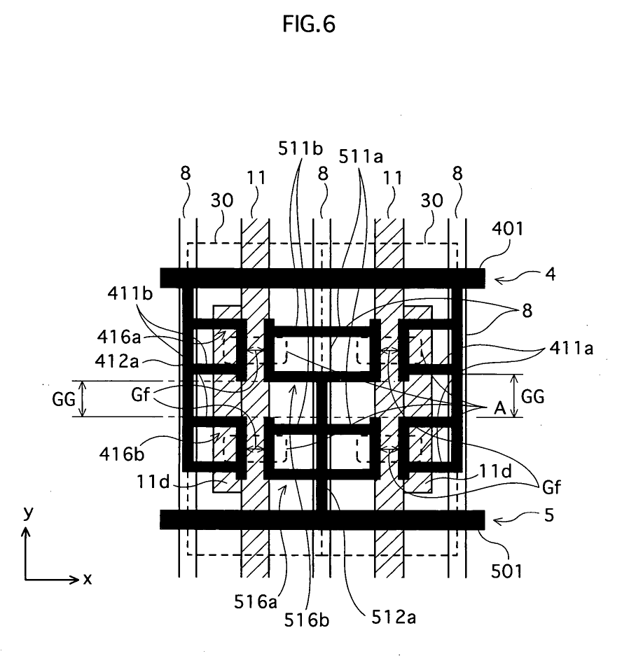

FIG. 7 shows a construction of a discharge cell in a conventional PDP;

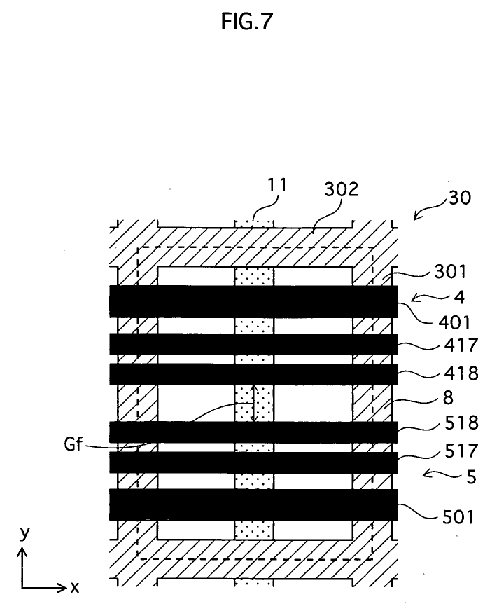

FIG. 8 shows a construction of a discharge cell in a conventional PDP; and

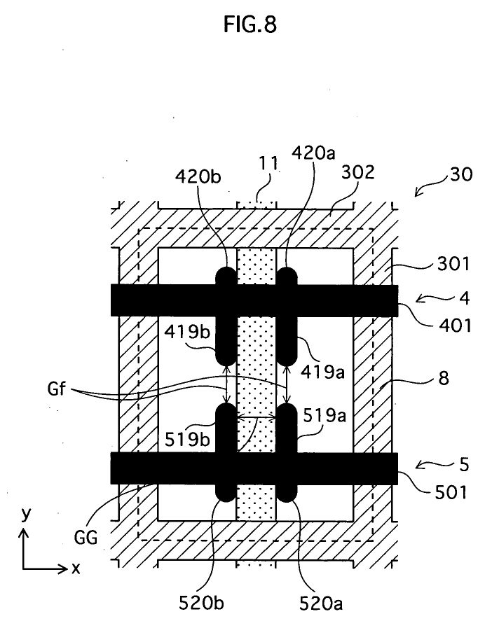

FIG. 9 is a partial perspective view showing the construction of a general PDP.

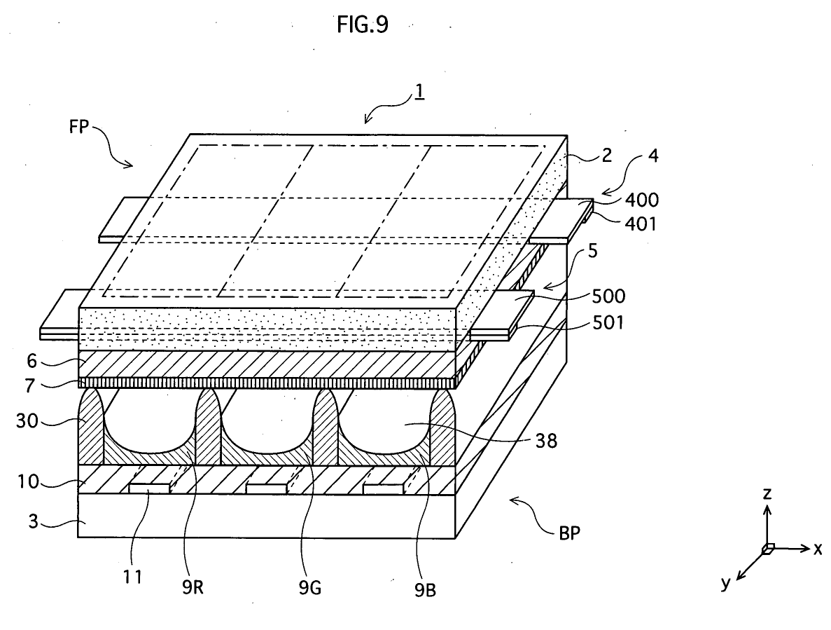

1. A plasma display panel in which a plurality of pairs of display electrodes extending in a row direction are aligned on a surface of a first substrate, a plurality of address electrodes extending in a column direction are disposed in a stripe pattern on a surface of a second substrate, the first and second substrates are disposed opposite each other so that the pairs of display electrodes and the address electrodes cross over sandwiching discharge space therebetween, and a discharge cell is formed corresponding to each crossover portion, wherein
the pairs of display electrodes are composed of a metallic material,
each display electrode of each pair of display electrodes comprises a base part extending in the row direction and a plurality of opposing parts extending from the base part into a discharge interval between the each pair of display electrodes, and
in each discharge cell, at least two discharge starting gaps are formed, each discharge starting gap existing between opposing parts that respectively belong each of the pair display electrodes and being at least partially over the address electrode, and discharge space existing between the each discharge starting gap and the address electrode.

2. The plasma display panel of claim 1, wherein
each opposing part is constructed from a connecting part that extends from the base part into the discharge interval between the pair of display electrodes and a main discharge part that extends in the row direction from the connecting part, the main discharge part being longer than a column-direction width of the connecting part, and
each discharge starting gap is formed between two main discharge parts that respectively belong to each of the pair of display electrodes.

3. The plasma display panel of claim 1, wherein
the opposing parts of each display electrode are symmetrically positioned between the pair of display electrodes.

4. The plasma display panel of claim 1, wherein
the address electrode includes, at least in each discharge cell, a plurality of branch parts extending in the column direction, and
in each discharge cell, each discharge starting gap is positioned over a branch part, discharge space existing between the each discharge starting gap and the branch part.

5. The plasma display panel of claim 1, wherein
the opposing parts are disposed at a plurality of locations along each display electrode in the row direction, and
each gap between adjacent opposing parts of a same polarity is narrower than a width of the address electrode.

6. The plasma display panel of claim 1, wherein
in each discharge cell, each display electrode is provided with a plurality of the opposing parts disposed in a column direction, and
a width of each discharge starting gap is set to be narrower than a width of the address electrode.

7. The plasma display panel of claim 1, wherein
auxiliary barrier ribs are individually disposed extending in the row direction between discharge cells that are adjacent in the column direction.

8. The plasma display panel of claim 1, wherein
a dielectric layer is provided so as to cover the display electrodes on the surface of the first substrate on which the display electrodes are aligned, and
in each discharge cell,
a thin layer area is provided in the dielectric layer in correspondence with each position of the main discharge gaps.

9. The plasma display panel of claim 1, wherein
a dielectric layer is provided so as to cover the display electrodes on the surface of the first substrate on which the display electrodes are disposed, and
in each discharge cell,
one or more thick layer area is provided in the dielectric layer in correspondence with positions of gaps between adjacent opposing parts of a same polarity.

10. The plasma display panel of claim 1, wherein
the metallic material includes at least one of Ag, Cu, Al, Cr and Ti, or includes at least one of Cr/Cu/Cr and Al—Nd.
